(19) United States
(12) Patent Application Publication
(10) Pub. No.: US 2004/0094910 A1
(43) Pub. Date: May 20, 2004

(54) Power-operated chuck or the like

(75) Inventor: Fritz Rehm, Oberteuringen (DE)

Correspondence Address: Pandiscio & Pandiscio, 470 Totten Pond Road, Waltham, MA, 02451, US

(73) Assignee: SMW-Autoblok Spannsysteme GmbH

(21) Appl. No.: 10/666,682

(22) Filed: Sep. 19, 2003

(30) Foreign Application Priority Data
Oct. 9, 2002 (DE) 102 47 154.1

(51) Int. Cl. B23B 31/02

(52) U.S. Cl. 279/126

(57) ABSTRACT

In a power-operated chuck (1) with clamping jaws (3) that are guided so they can move radially within a chuck body (2) and are in a drivable connection via intermediate elements with a clamping piston (4) upon which a hydraulic fluid can act in one or both directions and which is inserted in the chuck body (2) in such a way that it can move axially, a pressure sensor (41) installed in the chuck body (2) is provided in order to monitor the hydraulic fluid pressure existing in the pressure chambers (7 and 8) assigned to the clamping piston (4), the pressure sensor (41) being connected to one or both pressure chambers (7, 8) via hydraulic fluid channels (42, 43). Furthermore, the pressure sensor (41) has a receiver assigned to it which is connected to a unit (45) for evaluating the signals received from the pressure sensor (41).

This embodiment makes it possible for the pressure existing in a pressure chamber (7 or 8) to be continuously detected both when it is being charged and during operation and for this information to be used in order to control a machine tool.

The present invention relates to a power-operated chuck with clamping jaws that are guided so they can move radially within grooves in a rotating, driven chuck body, act on a workpiece to be clamped in the chuck and are in a drivable connection via intermediate elements, for example in the form of wedge hooks or wedge rods, with a clamping piston upon which a hydraulic fluid can act in one or both directions and can move axially within the chuck body, or it relates to a clamping device with a piston inserted in a cylinder upon which a hydraulic fluid can act in one or both directions and which is in a drivable connection with a clamping element, e.g. a power-operated chuck, either directly or via intermediate elements.

Setting pistons are frequently connected to the pressure chambers of a hydraulic power-operated chuck or a similar clamping device of the aforementioned kind, these setting pistons serving to indicate that the operating pressure is sufficient. However, no pressure measurement and continuous pressure monitoring takes place in this case, instead the position of the setting piston is merely checked at every revolution of the chuck or the cylinder (the position resulting from the supply of hydraulic fluid depending on the pressure which is building up or is enclosed) As a result, complex control devices are required when charging a pressure chamber, these control devices furthermore being susceptible to malfunctions.

Consequently, ascertaining the pressure in a pressure chamber is therefore not only complicated and difficult, it is also frequently inadequate since the particular position of the setting pistons, which are pushed against the force of return springs, only gives a limited indication of the level of the particular pressure. Often, this results in the machine tool with which the power-operated chuck or clamping device is operating being taken out of service incorrectly. Also, another aspect is that the machine tool might not be not switched off despite the fact that such a step would be prudent. Despite the design complexity of monitoring devices of prior art, they therefore fail to permit a safe operating procedure.

It is therefore the purpose of the present invention to equip a power-operated chuck or a clamping device in such a way that the pressure existing in a pressure chamber can be permanently detected both during charging and in operation and to allow this information to be used for controlling a machine tool. The design complexity required to achieve this should be kept to a low level whilst still guaranteeing trouble-free operation; above all, however, operating safety should be improved to a considerable extent. Accidents during work caused by inappropriate signals should be practically precluded.

In accordance with the present invention, these objectives are achieved in a power-operated chuck of the kind mentioned above in that a pressure sensor is installed in the chuck body in order to monitor the hydraulic fluid pressure always existing in one or both of the pressure chambers assigned to the clamping piston, the pressure sensor being connected to one or both pressure chambers of the clamping piston via hydraulic fluid channels, and that the pressure sensor has a receiver assigned to it which is connected to a unit for evaluating the signals received from the pressure sensor.

In a clamping device of the aforementioned type, it is advantageous to provide a pressure sensor installed in the cylinder in order to monitor the hydraulic fluid pressure always existing in one or both of the pressure chambers assigned to the piston, the pressure sensor being connected to one or both pressure chambers of the piston via hydraulic fluid channels and to assign to the pressure sensor a stationary receiver which is connected to a unit for evaluating the signals received from the pressure sensor.

The signals from the pressure sensor to the receiver can be transmitted in this case by means of radio waves emitted by an aerial or inductively with the help of a coupling module attached to the pressure sensor.

Furthermore, it is advantageous for the evaluation unit to be connected to the controller of the machine tools assigned to the chuck or the clamping device and to equip the pressure sensor with batteries in order to supply it with power, or to supply electrical power to the pressure sensor inductively via the receiver.

If a power-operated chuck or a clamping device is embodied in accordance with the present invention and equipped with a pressure sensor, it is easily possible to interrogate the pressure existing in a pressure chamber at any time and therefore both when a pressure chamber is being filled and during operating procedures. Consequently, changes in pressure can be detected immediately irrespective of the speed of rotation of the chuck or of the clamping device, making it possible to respond to the changed operating conditions at short notice.

The design complexity by means of which this can be achieved is extremely low, since it is only necessary to install a pressure sensor in the chuck or the clamping device and to connect it to the pressure chambers which are to be monitored. Nevertheless, trouble-free function is assured over a long period, particularly since the relevant signals are transmitted via radio or inductively which means no fixed or friction connections are necessary between the components assigned to one another. The embodiment in accordance with the proposed invention therefore significantly increases the operational safety of a power-operated chuck or clamping device and improves its operational characteristics.

The drawing shows two sample embodiments of a power-operated chuck or clamping device embodied in accordance with the present invention, the details of which are explained below. In the drawing,

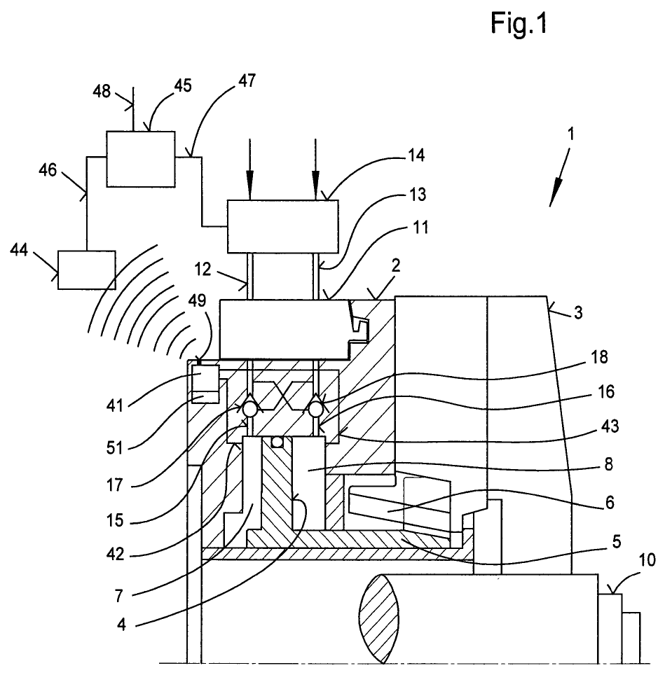

FIG. 1 shows a power-operated chuck with a pressure sensor installed in its chuck body, the signals from which can be transmitted via radio waves,

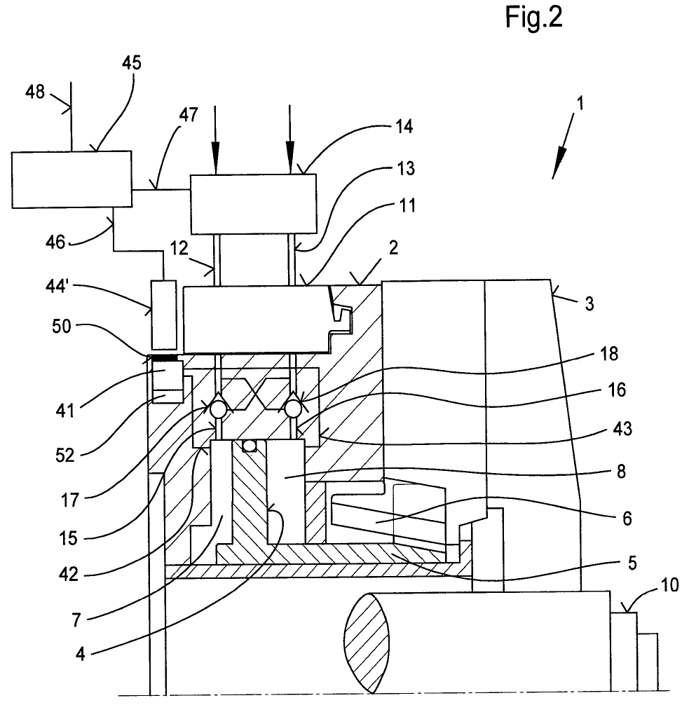

FIG. 2 shows the power-operated chuck in accordance with FIG. 1 with inductive transmission of the signals picked up by the pressure sensor,

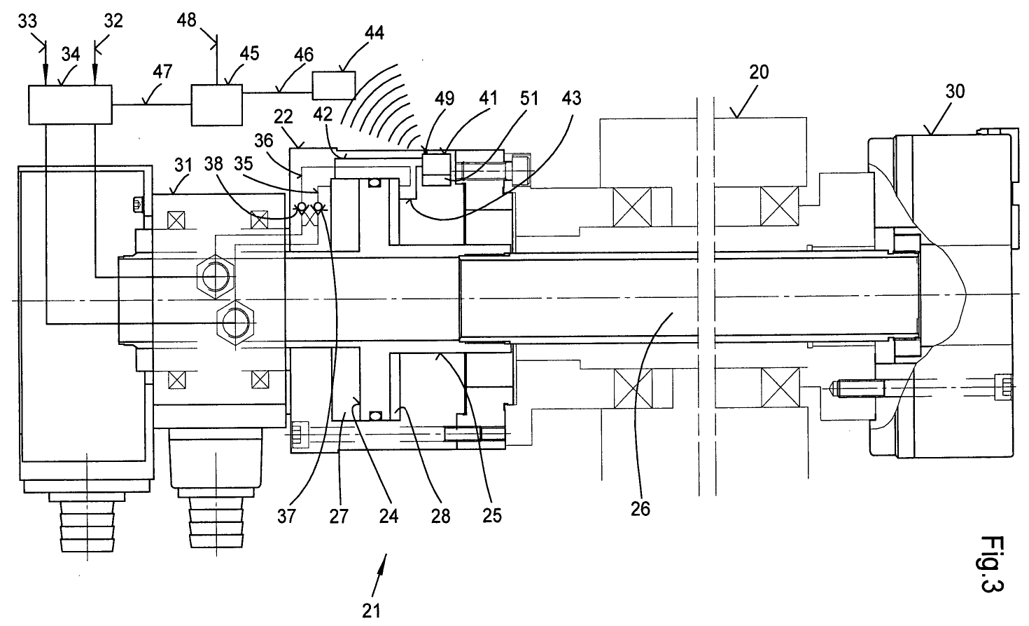

FIG. 3 shows a clamping device in an embodiment corresponding to FIG. 1,

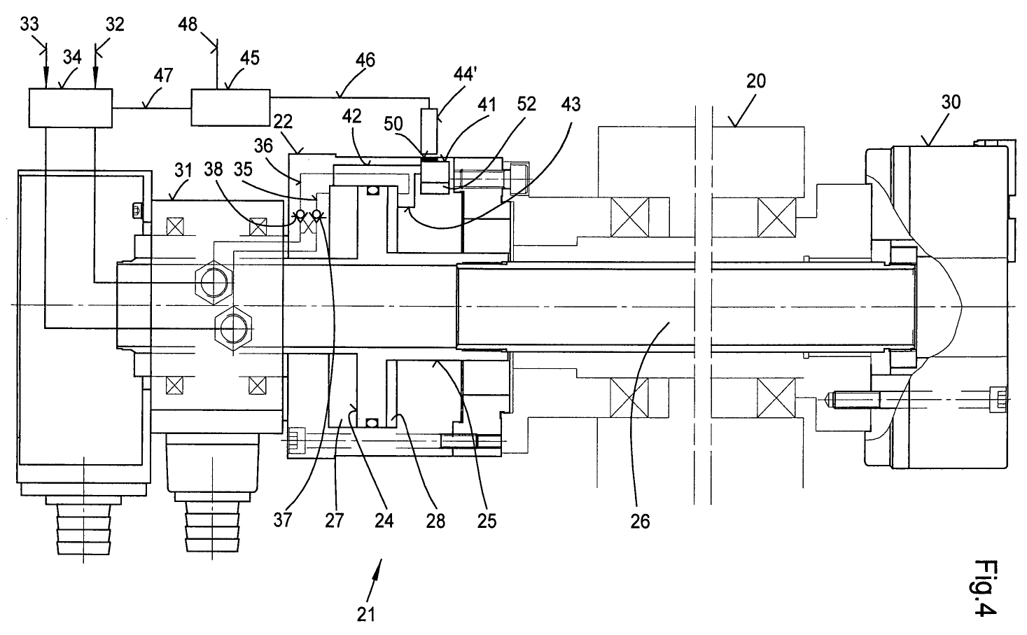

FIG. 4 shows the clamping device in accordance with FIG. 3 in an embodiment corresponding to FIG. 2.

The power-operated chuck illustrated in FIGS. 1 and 2 and identified by 1 chiefly consists of a rotating driven chuck body 2 with clamping jaws 3 that are guided so they can move radially within grooves, by means of which clamping jaws 3 a workpiece 10 to be machined can be clamped. The clamping jaws 3 in this case are in a drivable connection via wedge hooks 6 with a clamping piston 4 which can have hydraulic fluid acting on both sides and has a piston rod 5 formed onto it, into which the wedge hooks 6 engage.

The hydraulic fluid provided for pressurizing the clamping piston 4 is supplied alternately into the pressure chambers 7 and 8 assigned to it by means of a supply ring 11 in a stationary arrangement to which pressure lines 12 and 13 equipped with a control unit 14 are attached. The hydraulic fluid flows from the supply ring 11 to the pressure chambers 7 and 8 via channels 15 and 16. Releasable non-return valves 17 or 18 are inserted into the channels 15 and 16 to ensure that the pressure in the pressure chambers 7 and 8 is maintained during machining of the workpiece 10.

The particular pressure existing in pressure chambers 7 and 8 is of special importance because it determines the clamping force which is applied to the workpiece 10. A pressure sensor 41 is therefore installed in the chuck body 2 of the power-operated chuck 1 in order to measure the hydraulic fluid pressure with the pressure sensor 41 being connected to the pressure chambers 7 or 8 via control ducts 42 or 43, respectively, this arrangement permitting the pressure existing in the chambers 7 or 8 to act on the pressure sensor 41. In order to supply energy to the pressure sensor 41, it is provided with batteries 51.

The pressure values measured by the pressure sensor 41 are transmitted to a stationary receiver 44 with the help of an aerial 49 in the form of radio waves, the receiver 44 being connected to an evaluation unit 45 by means of a signal cable 46. Further signal cables 47 and 48 connect the evaluation unit 45 to the control unit 14 as well as to a machine controller (not illustrated).

If the pressure in one of the pressure chambers 7 and/or 8 reaches a critical value, therefore, the supply of hydraulic fluid can be immediately interrupted and/or the machine tool assigned to the power-operated chuck 1 can be stopped briefly. Since the pressure in pressure chambers 7 and 8 is constantly monitored, starting up the power-operated chuck 1 with inadequate clamping force exerted on the workpiece 10 is practically excluded, or the machine tool is stopped if this situation arises during operation.

In the embodiment shown in FIG. 2, the signals from the pressure sensor 41 are transmitted inductively to a receiver 44′. In order to achieve this, the pressure sensor 41 is provided with a coupling module 50 which interacts with the pressure sensor 41. In this arrangement, the receiver 44′ can also be used for transmitting power to batteries 52 which serve to power the pressure sensor 41.

In the clamping device 21 shown in FIGS. 3 and 4, the pressure existing in the pressure chambers 27 and 28 of a cylinder 22 in which a clamping piston 24 is inserted is monitored in the same way as in the embodiments of the power-operated chuck in accordance with FIGS. 1 and 2. The clamping piston 24 inserted in the cylinder 22 is in this case in a drivable connection with the clamping element 30, which can for example be embodied as a chuck, by means of a pull rod 26 which is attached to a piston rod 25 of the clamping piston 24.

The hydraulic fluid is supplied into pressure chambers 27 and 28 by means of an axial supply ring 31 located behind the cylinder 22 to which supply lines 32 and 33 are connected, and are themselves connected in turn to a control unit 34. The pressure chambers 27 and 28 are connected to the supply ring 31 by means of control lines 35 and 36 within which releasable non-return valves 37 or 38 are inserted.

A machine tool 20, to which the clamping device 21 is assigned, can therefore be started up or stopped with the help of the evaluation unit 45 depending on the pressure existing in pressure chambers 27 and/or 28. The values measured by the pressure sensor 41 are also transmitted via radio waves (FIG. 3) or inductively (FIG. 4).

1. A power-operated chuck (1) with clamping jaws (3) that are guided so they can move radially within grooves in a rotating, driven chuck body (2), act on a workpiece (10) to be clamped in the chuck (1) and are in a drivable connection via intermediate elements, for example in the form of wedge hooks (6) or wedge rods, with a clamping piston (4) upon which a hydraulic fluid can act in one or both directions and can move axially within the chuck body (2),
characterized in that,
a pressure sensor (41) is installed in the chuck body (2) in order to monitor the hydraulic fluid pressure always existing in one or both of the pressure chambers (7, 8) assigned to the clamping piston (4), the pressure sensor (41) being connected to one or both pressure chambers (7, 8) of the clamping piston (4) via hydraulic fluid channels (42, 43), and that the pressure sensor (41) has a receiver (44) assigned to it which is connected to a unit (45) for evaluating the signals received from the pressure sensor (41).

2. A clamping device (21) with a piston (24) inserted in a cylinder (22) upon which a hydraulic fluid can act in one or both directions and which is in a drivable connection with a clamping element (30), e.g. a power-operated chuck, either directly or via intermediate elements,
characterized in that
a pressure sensor (41) is installed in the cylinder (22) in order to monitor the hydraulic fluid pressure always existing in one or both of the pressure chambers (27, 28) assigned to the piston (24), the pressure sensor (41) being connected to one or both pressure chambers (27 or 28) of the piston (24) via hydraulic fluid channels (42, 43) and that the pressure sensor has a stationary receiver (44) assigned to it which is connected to a unit (45) for evaluating the signals received from the pressure sensor (41).

3. The power-operated chuck in accordance with claim 1 or 2,
characterized in that
The signals from the pressure sensor (41) to the receiver (44) are transmitted by means of radio waves emitted by an aerial (49) or inductively with the help of a coupling module (50) attached to the pressure sensor (41).

4. The power-operated chuck in accordance with claims 1 to 3,
characterized in that
the evaluation unit (45) is connected to the controller of the machine tool (20) assigned to the chuck (1) or the clamping device (21).

5. The power-operated chuck in accordance with claims 1 to 4,
characterized in that
the pressure sensor (41) is equipped with batteries (51) in order to supply it with power, or that electrical power is supplied to the pressure sensor (41) inductively via the receiver (44′).
